(19) United States
(12) Patent Application Publication
(10) Pub. No.: US 2008/0050472 A1
(43) Pub. Date: Feb. 28, 2008

(54) Supplemental dietary composition including caffeine, taurine and antioxidant

(76) Inventors: Marvin Heuer, Mississauga (CA); Ken Clement, Mississauga (CA); Shan Chaudhuri, Mississauga (CA); William Ha, Mississauga (CA)

Correspondence Address: TORYS LLP, 79 WELLINGTON ST. WEST, SUITE 3000, TORONTO, ON, M5K 1N2, CA

(21) Appl. No.: 11/839,936

(22) Filed: Aug. 16, 2007

Related U.S. Application Data
(63) Continuation-in-part of application No. 11/504,569, filed on Aug. 14, 2006.
(60) Provisional application No. 60/707,618, filed on Aug. 12, 2005.

(51) Int. Cl. A23L 1/302; A23F 3/16; A23L 2/00; A23L 1/28

(52) U.S. Cl. 426/72; 426/590; 426/655

(57) ABSTRACT

A dietary supplement and method for increasing energy and mental alertness of an individual, e.g. a human or an animal is provided comprising at least Caffeine Anhydrous, Taurine, an a plant extract providing antioxidant activity. Additionally, a method for increasing energy and metal alertness in an individual, e.g. a human or an animal is also provided.

### CROSS-REFERENCE TO RELATED APPLICATIONS

This application is a Continuation-in-Part and claims priority to U.S. patent application Ser. No. 11/504,569, filed Aug. 14, 2006 which in turn claims priority to Provisional Patent Application No. 60/707,618, filed Aug. 12, 2005, the entirety of which applications are incorporated herein by reference.

### FIELD OF THE INVENTION

The present invention is directed to a dietary supplement used to increase energy and the mental alertness of an individual. A method for the same is also presented.

### BACKGROUND OF THE INVENTION

The increasing awareness of improving one's health has driven demand for functional beverages, and drinks. A functional beverage is a beverage that not only quenches thirst, but also has added nutritional benefits. There are multiple categories of functional beverage such as, herb-enhanced fruit drinks, ready-to-drink (RTD) teas, sports drinks, energy drinks, and single-serve (SS) fresh juice. The additional benefits provided by these beverages when consumed vary depending upon the category. For example, sports drinks provide for rehydration and electrolyte replenishment while, vitamin-enriched water or meal replacement drinks provide a source of specific nutrition. Another category of functional beverages are energy drinks. Energy drinks are intended to produce an alert mental state in addition to a high-energy physical state. Energy drinks are particularly attractive to individuals participating in physically and mentally demanding activities in order to alleviate mental and physical fatigue.

The basis for most energy drinks is a combination of caffeine and a carbohydrate such as glucose. Two double-blind, placebo-controlled, cross-over studies demonstrated that a beverage containing glucose and caffeine can improve cognitive performance (Kennedy D O, Scholey A B. A glucose-caffeine ‘energy drink’ ameliorates subjective and performance deficits during prolonged cognitive demand. Appetite. 2004 June; 42(3):331-3). Combined glucose-caffeine drinks have also been shown to improve attention and performance on mental tasks requiring specific attention (Rao A, Hu H, Nobre A C. The effects of combined caffeine and glucose drinks on attention in the human brain. Nutr Neurosci. 2005 June; 8(3):141-53). Another study found that an energy drink including glucose and caffeine improved specific aspects of memory and attention in a synergistic way that could not be anticipated from individual components (Scholey A B, Kennedy D O. Cognitive and physiological effects of an “energy drink”: an evaluation of the whole drink and of glucose, caffeine and herbal flavouring fractions. Psychopharmacology (Berl). 2004 November ; 176(3-4):320-30).

### SUMMARY OF THE INVENTION

The foregoing needs and other needs and objectives that will become apparent for the following description are achieved in the present invention which comprises a composition and methods of a diet supplement for use in an individual, e.g., a human or an animal. The diet supplement of the present invention may comprise a combination of at least Caffeine Anhydrous, Taurine, and an extract of plant material to supply antioxidant activity.

According to an embodiment of the present invention, the diet supplement is provided in a ready-to-drink beverage form, which may be consumed several times per day. Consumed in this manner, said diet supplement quickly increases energy and mental alertness in an individual, e.g. a human or an animal during periods of fatigue or drowsiness or alternatively during periods when said user is need of heightened mental alertness or physical energy.

### DETAILED DESCRIPTION OF THE INVENTION

The present invention, in accordance with various embodiments thereof, provides a novel supplemental dietary composition comprising at least a combination of Caffeine Anhydrous, Taurine, and an extract of plant material supplying antioxidant activity. The plant material is selected from the group consisting of Acai, Mangosteen and Goji.

A used herein, the term “dietary supplement” includes dietary supplements, diet supplements, nutritional supplements, nutritional compositions, supplemental compositions and supplemental dietary compositions or those similarly envisioned and termed compositions not belonging to the conventional definition of pharmaceutical interventions as is known in the art. Furthermore, “nutritional compositions” as disclosed herein belong to category of compositions having at least one physiological function when administered to a mammal by conventional routes of administration.

In various embodiments of the present invention, the supplemental dietary composition may further comprise a combination of one or more of Green Tea extract, Pantothenoic acid (Vitamin B5), and Vitamin B12.

The supplemental dietary composition quickly increases energy and mental alertness in an individual, e.g. a human or an animal during periods of fatigue or drowsiness.

Caffeine Anhydrous

Caffeine is a naturally occurring xanthine alkaloid found in some plants where it acts as a natural pesticide. In humans it may have numerous beneficial effects. The most common use of caffeine as a supplement is as a central nervous system stimulant and performance enhancer, particularly in terms of mood, mental tasks and alertness (Smith A, Sutherland D, Christopher G. Effects of repeated doses of caffeine on mood and performance of alert and fatigued volunteers. J Psychopharmacol. 2005 November ; 19(6):620-6). Biochemically, caffeine binds to, but does not activate, adenosine receptors which are normally activated by adenosine to induce sleep (Shi D, Nikodijevic O, Jacobson K A, Daly J W. Chronic caffeine alters the density of adenosine, adrenergic, cholinergic, GABA, and serotonin receptors and calcium channels in mouse brain. Cell Mol Neurobiol. 1993 June ; 13(3):247-61) thereby antagonizing the receptors and inducing a more alert state. Furthermore, Caffeine has also been shown to increase the number of adenosine receptors and inhibit adenylate cyclase activity in the rat cerebral cortex (Ramkumar V, Bumgarner J R, Jacobson K A, Stiles G L. Multiple components of the A1 adenosine receptor-adenylate cyclase system are regulated in rat cerebral cortex by chronic caffeine ingestion. J Clin Invest. 1988 July ; 82(1):242-7). This leads to an increase in intracellular cyclic adenyl monophosphate (cAMP), an important signaling molecule, which results in increased epinephrine (adrenalin) and norepinephrin (noradrenalin) levels (Thong F S, Derave W, Kiens B, Graham T E, Urso B, Wojtaszewski J F, Hansen B F, Richter E A. Caffeine-induced impairment of insulin action but not insulin signaling in human skeletal muscle is reduced by exercise. Diabetes. 2002 March ; 51(3):583-90; Smith A, Brice C, Nash J, Rich N, Nutt D J. Caffeine and central noradrenaline: effects on mood, cognitive performance, eye movements and cardiovascular function. J Psychopharmacol. 2003 September ; 17(3):283-92). Levels of cAMP are also increased by the ability of caffeine to inhibit phosphodiesterases that degrade cAMP (Leblanc J, Richard D, Racotta I S. Metabolic and hormone-related responses to caffeine in rats. Pharmacol Res. 1995 September ; 32(3):129-33).

A meta-analysis including forty double-blind studies support the use of caffeine to increase physical endurance (Doherty M, Smith P M. Effects of caffeine ingestion on exercise testing: a meta-analysis. Int J Sport Nutr Exerc Metab. 2004 December ; 14(6):626-46). The stimulatory effect of caffeine has also been shown to increase the basal metabolic rate (Astrup A, Toubro S, Cannon S, Hein P, Breum L, Madsen J. Caffeine: a double-blind, placebo-controlled study of its thermogenic, metabolic, and cardiovascular effects in healthy volunteers. Am J Clin Nutr. 1990 May; 51(5):759-67; Dulloo A G, Geissler C A, Horton T, Collins A, Miller D S. Normal caffeine consumption: influence on thermogenesis and daily energy expenditure in lean and postobese human volunteers. Am J Clin Nutr. 1989 January ; 49(1):44-50) and improve athletic performance (Dodd S L, Herb R A, Powers S K. Caffeine and exercise performance. An update. Sports Med. 1993 January ; 15(1):14-23).

In various embodiments of the present invention which are set forth in greater detail in the example below, the diet supplement comprises Caffeine Anhydrous. A serving of the diet supplement comprises from about 0.050 g to about 1.000 g of Caffeine Anhydrous. The preferred dosage, in a serving of said diet supplement, comprises about 0.220 g of Caffeine Anhydrous.

Taurine

Taurine is an amino acid found primarily in nerve and muscle tissue. Taurine is generally considered to be a conditionally-essential amino acid, wherein it is only required under certain circumstances. However, as it is not utilized for protein synthesis, it is found in free form or in some small peptides.

One of the main roles of taurine is the regulation of fluid balance and it is also released by contracting muscles (Cuisinier C, Michotte De Welle J, Verbeeck R K, Poortmans J R, Ward R, Sturbois X, Francaux M. Role of taurine in osmoregulation during endurance exercise. Eur J Appl Physiol. 2002 October ; 87(6):489-95). Taurine has also been shown to modulate the contractile function of mammalian skeletal muscle (Bakker A J, Berg H M. Effect of taurine on sarcoplasmic reticulum function and force in skinned fast-twitch skeletal muscle fibres of the rat. J Physiol. 2002 Jan. 1; 538(Pt 1):185-94). In rats, the taurine concentration in muscle decreases as a result of exercise (Matsuzaki Y, Miyazaki T, Miyakawa S, Bouscarel B, Ikegami T, Tanaka N. Decreased taurine concentration in skeletal muscles after exercise for various durations. Med Sci Sports Exerc. 2002 May; 34(5):793-7) and oral supplementation with taurine can maintain the concentration of taurine in muscles and prolong exercise performance (Miyazaki T, Matsuzaki Y, Ikegami T, Miyakawa S, Doy M, Tanaka N, Bouscarel B. Optimal and effective oral dose of taurine to prolong exercise performance in rat. Amino Acids. 2004 December ; 27(3-4):291-8; Yatabe Y, Miyakawa S, Miyazaki T, Matsuzaki Y, Ochiai N. Effects of taurine administration in rat skeletal muscles on exercise. J Orthop Sci. 2003; 8(3):415-9). Supplementation with taurine has been shown to reduce exercise-induced oxidative damage and enhance recovery (Zhang M, Izumi I, Kagamimori S, Sokejima S, Yamagami T, Liu Z, Qi B. Role of taurine supplementation to prevent exercise-induced oxidative stress in healthy young men. Amino Acids. 2004 March ; 26(2):203-7).

In various embodiments of the present invention which are set forth in greater detail in the example below, the diet supplement comprises Taurine. A serving of the diet supplement comprises from about 0.500 g to about 2.000 g of Taurine. The preferred dosage, in a serving of said diet supplement, comprises about 1.000 g of Taurine.

Anitoxidants

Dietary plant-based polyphenols are reported to convey numerous health benefits including prevention of diabetes, neurodegenerative disease, cardiovascular disease and cancer. Polyphenols are the highest source of antioxidants in the human diet (Scalbert A, Johnson I T, Saltmarsh M. Polyphenols: antioxidants and beyond. Am J Clin Nutr. 2005 January ; 81(1 Suppl):215S-217S). Plants contain, among numerous nutrients, a variety of polyphenols (Manach C, Williamson G, Morand C, Scalbert A, Remesy C. Bioavailability and bioefficacy of polyphenols in humans. I. Review of 97 bioavailability studies. Am J Clin Nutr. 2005 January ; 81(1 Suppl):230S-242S). The health benefits provided by antioxidants are due to their ability to counter the damaging effects of reactive oxygen species, or free radicals. Polyphenols from different sources have different structures and different properties. Furthermore, similar polyphenols form different sources have different properties such as absorption and biovailability (de Vries J H, Hollman P C, Meyboom S, Buysman M N, Zock P L, van Staveren W A, Katan M B. Plasma concentrations and urinary excretion of the antioxidant flavonols quercetin and kaempferol as biomarkers for dietary intake. Am J Clin Nutr. 1998 July ; 68(1):60-5). Therefore, it would be advantageous to provide given polyphenols derived from different sources.

Oxygen is utilized in the mitochondria of mammals for energy production by producing adenosine triphosphate (ATP). Many biological processes result in the production of free radicals which, while serving a purpose at low levels (e.g. redox regulation), can damage proteins, lipids and DNA at higher levels (Halliwell B. Reactive species and antioxidants. Redox biology is a fundamental theme of aerobic life. Plant Physiol. 2006 June ; 141(2):312-22). Due to the usage of oxygen by the mitochondria, the mitochondria are often subjected to damaging levels of oxidants which can inhibit the mitochondrial enzymes involved in energy production, thereby reducing ATP production capacity.

Acai

Euterpe oleraceae, commonly known as acai, is a fruit native to tropical areas of Central and South America. Acai fruit has been shown to possess antioxidant activity (Del Pozo-lnsfran D, Brenes C H, Talcott S T. Phytochemical composition and pigment stability of Acai (Euterpe oleracea Mart.). Agric Food Chem. 2004 March 24; 52(6):1539-45). The antioxidant activity of Acai differs with respect to specific oxidants (Lichtenthaler R, Rodrigues R B, Maia J G, Papagiannopoulos M, Fabricius H, Marx F. Total oxidant scavenging capacities of Euterpe oleracea Mart. (Acai) fruits. Int J Food Sci Nutr. 2005 Febuary ; 56(1):53-64).

Mangosteen

The fruit of the tropical evergreen tree Garcinia mangostana is sometimes termed ‘the queen of fruits’. Mangosteen has been used as a component of traditional medicine in native growth locals. Mangosteen has been shown to provide constituents with antioxidant activity (Moongkarndi P, Kosem N, Kaslungka S, Luanratana O, Pongpan N, Neungton N. Antiproliferation, antioxidation and induction of apoptosis by Garcinia mangostana (mangosteen) on SKBR3 human breast cancer cell line. J Ethnopharmacol. 2004 January ; 90(1): 161-6).

Goji

Wolfberries, the common name for Lycium barbarum, also called Goji berries, are a highly nutritionally rich fruit originally grown in Europe and now cultivated in China where it has been used in traditional Chinese medicine for nearly 2,000 years. The active polysaccharide extracts are believed to enhance immune system function, improve eyesight, protect the liver, boost sperm production, and improve circulation. The active polysaccharide extracts of Goji have demonstrated antioxidant activity (Wu H, Guo H, Zhao R. Effect of Lycium barbarum polysaccharide on the improvement of antioxidant ability and DNA damage in NIDDM rats.Yakugaku Zasshi. 2006 May; 126(5):365-71) which is likely responsible for some reported benefits.

Green Tea

All teas (green, black, white and oolong) are derived from the same plant (Camellia sinensis) however different methods of processing are employed, resulting in different proportions of active compounds. Indeed, Green tea undergoes the least processing, thereby leaving more active compounds.

The active compounds of tea are a family of polyphenols, particularly the catechins. The most active specific compound is the catechin epigallocatechin gallate (ECGC) which comprises 10-50% of the total catechins (Kao Y H, Hiipakka R A, Liao S. Modulation of endocrine systems and food intake by green tea epigallocatechin gallate. Endocrinology. 2000 March ; 141(3):980-7). The catechins in Green tea are also known to inhibit catechol-O-methyl-transferase (COMT), an enzyme that degrades norepinephrine (Borchardt R T, Huber J A. Catechol O-methyltransferase. 5. Structure-activity relationships for inhibition by flavonoids. J Med Chem. 1975 January ; 18(1):120-2). Norepinephrine and epinephrine increase the levels of cAMP (MacGregor D A, Prielipp R C, Butterworth J F 4th, James R L, Royster R L. Relative efficacy and potency of beta-adrenoceptor agonists for generating cAMP in human lymphocytes. Chest. 1996 January ; 109(1):194-200). Thus, Green tea may be expected to have effects similar to caffeine. In fact, the increased energy expenditure stimulated by Green tea (Dulloo A G, Duret C, Rohrer D, Girardier L, Mensi N, Fathi M, Chantre P, Vandermander J. Efficacy of a green tea extract rich in catechin polyphenols and caffeine in increasing 24-h energy expenditure and fat oxidation in humans. Am J Clin Nutr. 1999 December ; 70(6):1040-5) is synergistically enhanced by caffeine (Dulloo A G, Seydoux J, Girardier L, Chantre P, Vandermander J. Green tea and thermogenesis: interactions between catechin-polyphenols, caffeine and sympathetic activity. Int J Obes Relat Metab Disord. 2000 Febuary ; 24(2):252-8).

In various embodiments of the present invention which are set forth in greater detail in the example below, the diet supplement comprises at least one plant extract providing antioxidant activity. A serving of the diet supplement comprises from about 0.0005 g to about 0.025 g of at least one plant extract providing antioxidant activity. Preferably, a serving of the dietary supplement comprises more than one plant extract providing antioxidant activity.

Calcium Pantothenate (Vitamin B5)

Calcium Pantothenate is a supplemental form of Pantothenic Acid. Pantothenic Acid (vitamin B5) is one of eight water-soluble B-vitamins and is important in the metabolism of carbohydrates. Moreover, Pantothenic Acid is a precursor of coenzyme A which is essential for carbohydrate metabolism. Interestingly, studies have shown that the typical North American diet is low in Pantothenic Acid (Tarr J B, Tamura T, Stokstad E L. Availability of vitamin B6 and pantothenate in an average American diet in man. Am J Clin Nutr. 1981 July ; 34(7):1328-37).

In various embodiments of the present invention which are set forth in greater detail in the example set forth below, the diet supplement comprises Calcium Pantothenate. A serving of the diet supplement comprises from about 0.005 g to about 0.050 g of Calcium Pantothenate. The preferred dosage, in a serving of said diet supplement, comprises about 0.010 g of Calcium Pantothenate.

Cyanocobalamin (Vitamin B12)

Vitamin B12 (Cobalamin) is a cobalt-containing vitamin in the Vitamin B complex. It is obtained in the diet mainly from meat and dairy products. Vitamin B12 is involved in the metabolism of proteins, fats, and carbohydrates and is needed to produce succinyl CoA, an intermediary in the Krebs cycle that generates ATP for energy. Vitamin B12 deficiency has been linked to anemia and a number of neuropsychiatric disorders which can be effectively treated with oral supplementation (Oh R, Brown D L. Vitamin B12 deficiency. Am Fam Physician. 2003 Mar. 1 ; 67(5):979-86).

In various embodiments of the present invention which are set forth in greater detail in the example set forth below, the diet supplement comprises Vitamin B12. A serving of the diet supplement comprises from about 0.00005 g to about 0.00500 g of Vitamin B12. The preferred dosage, in a serving of said diet supplement, comprises about 0.0005 g of Vitamin B12.

In an embodiment of the present invention, which is set forth in greater detail in the examples below, the supplemental dietary composition comprises at least Caffeine Anhydrous, Taurine, and plant extracts supplying antioxidant activity. The supplemental dietary composition may further comprise one or more of Green tea extract, Pantothenoic acid (Vitamin B5) and Vitamin B12.

According to various embodiments of the present invention, the supplemental dietary composition may be consumed in any form. For instance, the dosage form of the supplemental dietary composition may be provided as, e.g. a beverage mix, a liquid beverage, e.g. an energy drink, a ready-to-drink beverage, a ready-to-eat bar, a capsule, a tablet, a caplet, or as a dietary gel. The most preferred dosage form is as an energy drink product. The supplemental dietary composition may be consumed any number of times per day in order to obtain any one or more of the benefits set forth above. For example, in an embodiment, the supplemental dietary composition may be consumed one or two times per day whenever any one of the benefits set forth above is desired. Thus, the duration of any of the benefits set forth above may be prolonged by repeated consumption of the supplemental dietary composition or a portion thereof.

Furthermore, the dosage form of the supplemental dietary composition may be provided in accordance with customary processing techniques for herbal and/or dietary supplements in any of the forms mentioned above. Also, the supplemental dietary composition set forth in the example embodiment herein contains any appropriate number and type of excipients, as is well known in the art.

Although the following examples illustrate the practice of the present invention in two of its embodiments, the examples should not be construed as limiting the scope of the invention. Other embodiments will be apparent to one skilled in the art from consideration of the specification of the following example.

### EXAMPLES

### EXAMPLE 1

A diet supplement for increasing energy and mental alertness in an individual, e.g. a human or an animal during periods of fatigue or drowsiness is provided in a two (2) fluid ounce serving, the diet supplement comprising about 0.2200 g of Caffeine Anhydrous, about 1.000 g of Taurine, and about 0.001 g of an extract of Goji per serving.

Directions: As a diet supplement, at least two (2) fluid ounces of said diet supplement are administered orally during periods of fatigue or drowsiness or alternatively during periods wherein the user is in need of heightened mental alertness or physical energy. Each two (2) fluid ounce serving may be consumed as needed throughout the day.

### EXAMPLE 2

A diet supplement for increasing energy and mental alertness in an individual, e.g. a human or an animal during periods of fatigue or drowsiness is provided in a two (2) fluid ounce serving, the diet supplement comprising about 0.2000 g of Caffeine Anhydrous, about 1.000 g of Taurine, about 0.001 g of an extract of Acai, about 0.001 g of an extract of Mangosteen, about 0.001 g of an extract of Green tea, about 0.010 g of Calcium Pantothenate, and about 0.0005 g of Vitamin B12 per serving.

Directions: As a diet supplement, at least one (1) fluid ounce of said diet supplement is administered orally during periods of fatigue or drowsiness or alternatively during periods wherein the user is in need of heightened mental alertness or physical energy. At a subsequent time a second fluid ounce of said diet supplement is administered orally to prolong beneficial effects.

Extensions and Alternatives

In the foregoing specification, the invention has been described with specific embodiments thereof; however, it will be evident that various modifications and changes may be made thereto without departing from the broader spirit and scope of the invention.

What is claimed:

1. A composition to increase energy and the mental alertness of an individual comprising;
from about 0.050 g to about 1.000 g of Caffeine Anhydrous, from about 0.500 g to about 2.000 g of Taurine, and from about 0.0005 g to about 0.025 g of at least one plant extract providing antioxidant activity.

2. The composition of claim 1, wherein the amount of Caffeine Anhydrous is about 0.220 g, the amount of Taurine is about 1.000 g and the amount of plant extract providing antioxidant activity is about 0.001 g.

3. The composition of claim 1, wherein said plant material selected from the group consisting of Acai, Mangosteen and Goji.

4. The composition of claim 1, further comprising Green tea extract.

5. The composition of claim 4, wherein the amount of Green tea extract is from about 0.0005 g to about 0.025 g.

6. The composition of claim 4, wherein the amount of Green tea extract is about 0.001 g.

7. The composition of claim 1, further comprising Calcium Pantothenate.

8. The composition of claim 7, wherein the amount of Calcium Pantothenate is from about 0.005 g to about 0.050 g.

9. The composition of claim 7, wherein the amount of Calcium Pantothenate is about 0.010 g.

10. The composition of claim 1, further comprising Vitamin B12.

11. The composition of claim 10, wherein the amount of Vitamin B12 is from about 0.00005 g to about 0.00500 g.

12. The composition of claim 10, wherein the amount of Vitamin B12 is about 0.0005 g.

13. A method of increasing energy and the mental alertness of an individual comprising the step of administering a composition comprising;
from about 0.050 g to about 1.000 g of of Caffeine Anhydrous, from about 0.500 g to about 2.000 g of Taurine, and from about 0.0005 g to about 0.025 g of at least one plant extract providing antioxidant activity.

14. The method of claim 13, wherein the composition is administered orally.

15. The method of claim 13, wherein the amount of Caffeine Anhydrous is about 0.220 g, the amount of Taurine is about 1.000 g and the amount of plant extract providing antioxidant activity is about 0.001 g.

16. The method of claim 13, wherein said plant material selected from the group consisting of Acai, Mangosteen and Goji.

17. The method of claim 13, further comprising from about 0.0005 g to about 0.025 g of Green tea extract

18. The method of claim 13, further comprising from about 0.005 g to about 0.050 g of Calcium Pantothenate.

19. The method of claim 13, further comprising from about 0.00005 g to about 0.00500 g of Vitamin B12.

20. The method claim 13, wherein said composition is provided as a ready-to-drink beverage product.
